(19) United States
(12) Patent Application Publication
(10) Pub. No.: US 2006/0075727 A1
(43) Pub. Date: Apr. 13, 2006

(54) Cyclone dust collecting apparatus and vacuum cleaner having the same

(75) Inventors: Tak-Soo Kim, Gwangju-City (KR); Yong-Hee Lee, Gwangju-City (KR)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Samsung Gwangju Electronics Co., Ltd.

(21) Appl. No.: 11/072,858

(22) Filed: Mar. 4, 2005

(30) Foreign Application Priority Data
Oct. 12, 2004 (KR) 2004-81244

(51) Int. Cl. B01D 47/00

(52) U.S. Cl. 55/337

(57) ABSTRACT

A cyclone dust collecting apparatus having a cyclone body, a press filter provided in the cyclone body, and a cyclone filter spaced from the press filter is provided. A part of air in the cyclone body is discharged through the press filter, and the remaining air is discharged through the cyclone filter.

### CROSS-REFERENCE TO RELATED APPLICATIONS

This application claims the benefit of Korean Patent Application No. 2004-81244 filed on Oct. 12, 2004, in the Korean Intellectual Property Office, the disclosure of which is incorporated herein by reference in its entirety.

### BACKGROUND OF THE INVENTION

1. Field of the Invention

The present invention relates to a cyclone dust collecting apparatus and a vacuum cleaner having the same.

2. Description of the Related Art

Generally, a cyclone dust collecting apparatus comprises a cyclone body with an inlet passage and an air discharge pipe, and a cyclone filter disposed at an inlet of a discharge pipe.

Dust-laden air flowed in the inlet passage is separated into dust and air by a centrifugal force in a cyclone body, and the air is discharged via the cyclone filter from the cyclone dust collecting apparatus while the dust is collected on a bottom of the cyclone body.

The conventional cyclone collecting apparatus, however, can not prevent the cyclone filter from blocking due to dusts.

In the conventional cyclone dust collecting apparatus, a suction force is transmitted only via the cyclone filter and a discharge pipe, and therefore, pressure loss can not be prevented in the complicated suction force transmit route, and the separated dust is collected as it is, without press, in the cyclone dust collecting apparatus.

### SUMMARY OF THE INVENTION

The present invention has been conceived to solve the above-mentioned problems occurring in the prior art, and an aspect of the present invention is to provide a cyclone dust collecting apparatus capable of preventing dust from flowing back and a vacuum cleaner having the same.

Another aspect of the present invention is to provide a cyclone dust collecting apparatus reducing a pressure loss and a vacuum cleaner having the same.

Yet another aspect of the present invention is to provide a cyclone dust collecting apparatus having an increased capacity of collecting dust and a vacuum cleaner having the same.

In order to achieve the above aspects, there is provided a cyclone dust collecting apparatus comprising: a cyclone body; a press filter provided in the cyclone body; and a cyclone filter spaced from the press filter, and a part of air in the cyclone body is discharged through the press filter, and the remaining air is discharged through the cyclone filter.

The cyclone dust collecting apparatus may further comprise a discharge pipe in the cyclone body, and the cyclone filter is disposed at a top portion of the discharge pipe, and air passing through the cyclone filter is discharged through the discharge pipe.

The cyclone body may be comprise a sidewall and a bottom surface, and at least one press filter mounting opening and an air discharge opening are configured at the bottom surface.

The discharge pipe may be vertically provided in the cyclone body and connected with the air discharge opening in fluid-communication.

The bottom surface of the cyclone body may be pivotable with regard to the sidewall to be able to open.

A plurality of the press filter mounting opening may be radially disposed along the air discharge opening. The press filter mounting opening may take on configuration of a trapezoid.

The air discharge opening and the press filter mounting opening are connected with the same suction source in fluid-communication.

In order to achieve the above aspects, there is also provided a vacuum cleaner having a cleaner body with a suction source, a suction brush connected with the cleaner body to draw in contaminants from a cleaning surface, and a cyclone dust collecting apparatus detachably mounted in the cleaner body to separate dust from dust-laden air drawn in from the suction brush, wherein the cyclone dust collecting apparatus comprises a cyclone body, a press filter disposed at a bottom surface of the cyclone body, and a cyclone filter spaced from the press filter, and a part of air in the cyclone body is discharged through the press filter and the remaining air is discharged through the cyclone filter.

The vacuum cleaner may further comprises a discharge pipe vertically provided in the cyclone body, wherein at least one press filter mounting opening and an air discharge opening are disposed at the bottom surface, and air passing through the cyclone filter is discharged via the discharge pipe through the air discharge opening.

The discharge pipe and the press filter mounting opening are connected with the same suction source in fluid-communication.

### BRIEF DESCRIPTION OF THE DRAWINGS

The above and other aspects, features and advantages of the present invention will be more apparent from the following detailed description taken with reference to the accompanying drawings, in which:

FIG. 1 is a schematically perspective view of a vacuum cleaner having a cyclone dust collecting apparatus according to an embodiment of the present invention;

FIG. 2 is a partial-sectional view of a cyclone dust collecting apparatus of FIG. 1;

FIG. 3 is a view for explaining a press filter mounting hole and a press filter of FIG. 2; and

FIG. 4 is a sectional view of the brush assembly taken on IV-IV line of FIG. 1.

### DETAILED DESCRIPTION OF THE EXEMPLARY EMBODIMENTS

Certain embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

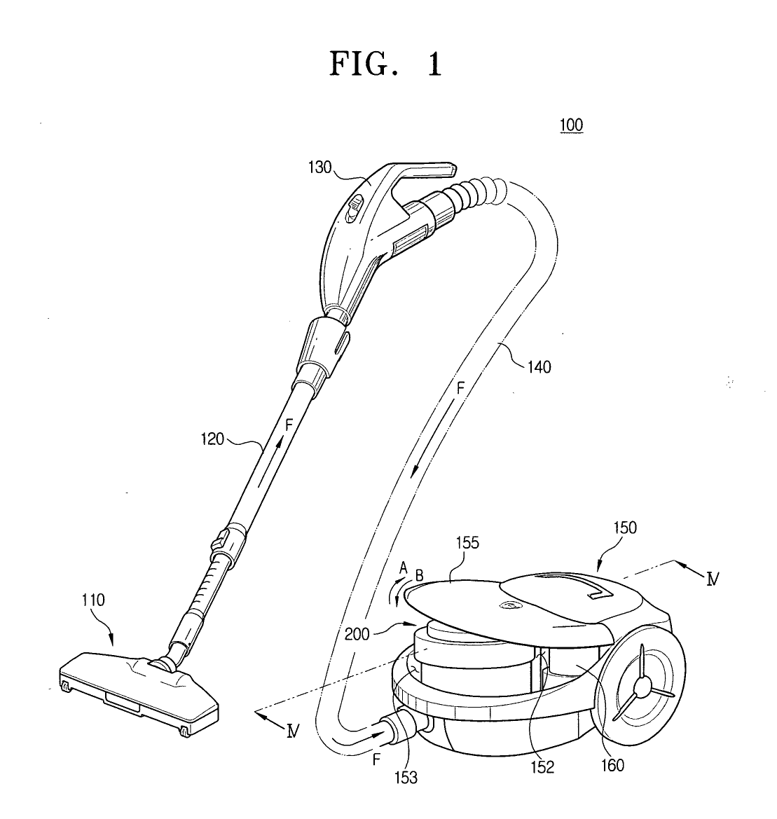

Referring to FIG. 1, a vacuum cleaner 100 comprises a cleaner body 150, a suction brush 110 for drawing in contaminants from a cleaning surface, a manipulation part 130 for manipulating the vacuum cleaner 100, an extension pipe 120 for connecting the manipulation part 130, a flexible hose 140 for connecting the manipulation part 130 and the cleaner body 150, and a cyclone dust collecting apparatus 200.

A driving chamber 152 and a contaminant collecting chamber 153 are provided in the cleaner body 150.

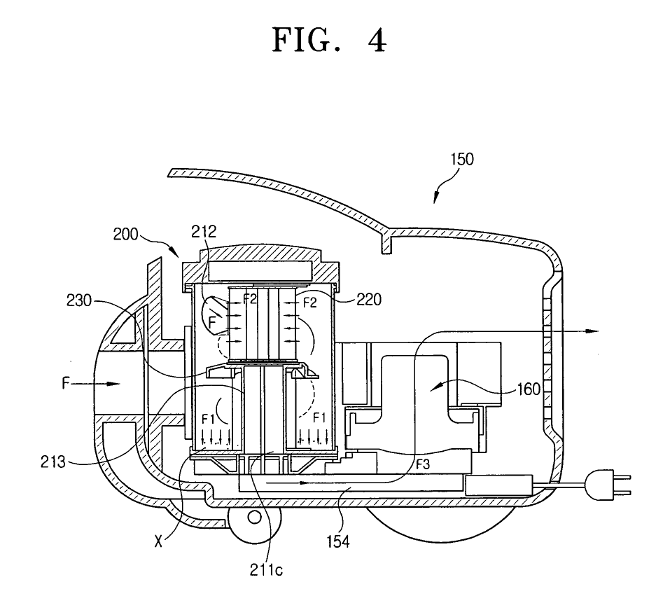

A suction source 160 is arranged in parallel with the cyclone dust collecting apparatus 200 in the driving chamber 152, and the cyclone dust collecting apparatus 200 is connected with the suction source 160 via a connecting passage 154 as shown in FIG. 4. The suction source 160 is so arranged in parallel with the cyclone dust collecting apparatus 200 that the cleaner body 150 can be lower in height and the vacuum cleaner 100 can be compact-sized.

The cyclone dust collecting apparatus 200 is removably mounted in the contaminant collecting chamber 153. In specific, an openable upper cover 155 at top portion of the cleaner body 150 is opened in a direction of arrow A, the cyclone dust collecting apparatus 200 is inserted into the contaminants collecting chamber 153, and the upper cover 155 is closed in a direction of arrow B in order to mount the cyclone dust collecting apparatus 200.

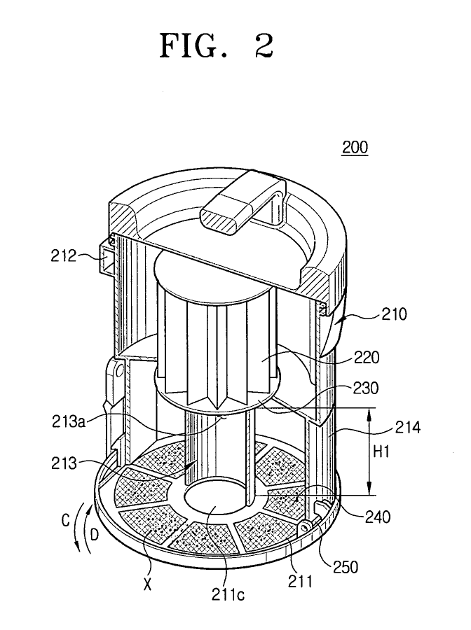

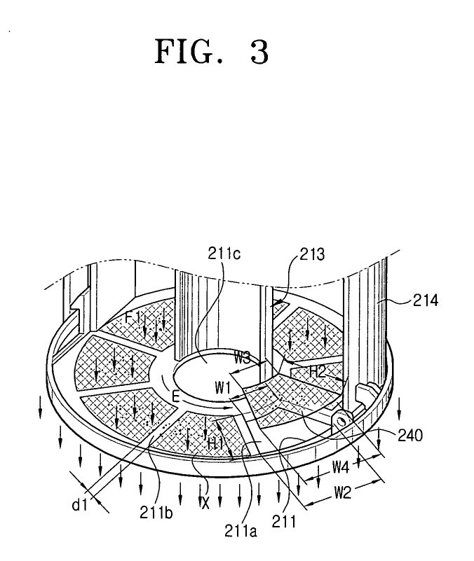

Referring to FIGS. 2 and 3, the cyclone dust collecting apparatus 200 comprises a cyclone body 210, a cyclone filter 220, a blocking member 230 and a press filter 240.

The cyclone body 210 has a sidewall 214 and a bottom surface 211. A suction passage 212 is disposed at the sidewall 214 and a press filter mounting hole 211a and an air discharge opening 211c connected with a discharge pipe 213 in fluid-communication are disposed at the bottom surface 211.

Dust-laden air is centrifugally separated into dust and air in the cyclone body 210 and the separated dust is collected on the bottom surface 211 of the cyclone body 210.

The bottom surface 211 of the cyclone body 210 is integrally formed with the cyclone body 210, or as exemplified in the present embodiment separately formed from the cyclone body 210 and pivotably connected with the sidewall 214 by a hinge 250.

The bottom surface 211 of the cyclone body 210 is opened in a direction of arrow C to remove the dust collected on the bottom surface 211, and then the bottom surface 211 is closed in a direction of arrow D to keep cleaning.

The suction passage is disposed at the sidewall 214 of the cyclone body 210 and an inlet for dust-laden air through a flexible hose 140 (refer to FIG. 1) flowing in direction of arrow F into the cyclone body 210. The suction passage 212 may be a duct in a proper length enough to rotate the dust-laden air when the dust-laden air is flowed in the cyclone body 210.

The discharge pipe 213 is a passage discharging the air separated from the dust-laden air, and is vertically mounted to the bottom surface 211 to connect the air discharge opening 211c penetrating a center of the bottom surface 211.

The discharge pipe 213 has a proper height H1 so as to prevent the dust collected on the bottom surface 211 from blocking the cyclone filter 220 disposed at an entrance 213a of the discharge pipe 213.

In the present embodiment, the discharge pipe 213 is separately manufactured, however, may be integrally manufactured with the bottom surface 211.

The cyclone filter 220 is disposed at the entrance 213a of the discharge pipe 213, and secondly filters the dust having been unseparated by an centrifugal force.

The blocking member 230 is disposed between the cyclone filter 220 and the entrance 213a of the discharge pipe 213, and prevents dust collected on the bottom surface 211 of the cyclone body 210 from rising towards the cyclone filter 220. The blocking member 230 takes on configuration of a substantially circular plate, but various configurations can be applied.

Referring to FIG. 3, a plurality of the press filter mounting openings 211a are spaced apart along the air discharge opening 211c, and supporting parts 211b are disposed between the press filter mounting openings 211a.

The supporting part 211b is a part of the bottom surface 211 except for the press filter mounting opening 211a for the bottom surface 211 to maintain regular strength.

Particularly, the press filter mounting opening 211a is penetrated in the bottom surface 211 as a certain configuration, and the eight press filter mounting openings 211a are disposed along the discharge pipe 213 in direction of arrow E keeping a regular interval d1 to each other.

In the press filter mounting opening 211a, the length of a small circular arc is W1 and the length of a large circular arc is W2. The small and large circular arcs are spaced apart by H1 and the area connecting W1 and W2 takes on the configuration of trapezoid.

If the press filter mounting opening 211a is formed as a trapezoid, the supporting part 211b for supporting the weight of dust collected on the bottom surface 211 of the cyclone body 210 and wide press filter mounting opening 211a can be provided at a same time.

The surface area of the press filter 240 mounted to the press filter mounting opening 211a can be also wide due to the wide filter mounting opening 211a such that most of dust X is collected on the press filter 240 rather than the supporting part 211b.

The air passing through the press filter 240 presses most of dust collected on the bottom surface 211 of the cyclone body 210 on the press filter 240 such that the collected dust can be prevented from flowing back to the cyclone filter 220, and the dust collecting volume can increase due to the pressure of dust.

Additionally, a suction force can be transmitted via the press filter 240 so as to decrease pressure loss as compared with a conventional cyclone dust collecting apparatus wherein a suction force can be transmitted only via a complicated suction force transmission passage, i.e., the cyclone filter 220 (refer to FIG. 2) and the discharge pipe 213.

The press filter 240 is made of a general filter material to filter dust, and has the same configuration of the press filter mounting opening 211a. The press filter 240 takes on the configuration of a trapezoid comprising a small circular arc length W3, a large circular arc length W4 and the distance H2 between the small circular arc and the large circular arc.

With longer the small circular arc length W3, the large circular arc length W4 and the distance H2 than the small circular arc length W1, the large circular arc length W2 and the distance H1 of the press filter mounting opening 211a, the press filter 240 may be press-fitted into the press filter mounting opening 211a, or the press filter 240 may be glued to the supporting part 211b covering the press filter mounting opening 211a.

The press filter mounting opening 211a and the press filter 240 may be preferably formed as a trapezoid, but various configurations may be applied as necessary.

The operation of the vacuum cleaner 100 having the above construction will be explained hereinafter.

Referring to FIGS. 1 and 4, a suction force generated from the suction resource 160 is transmitted via the connection passage 154 and the cyclone dust collecting apparatus 200 to the suction brush 110.

The suction brush 110 draws in dust-laden air from a cleaning surface. The drawn dust-laden air sequentially passes in a direction of arrow F the suction brush 110, the extension pipe 120 and the flexible hose 140 and flows in via the suction passage 212 of the dust collecting apparatus 200 into the cyclone body 210

Referring to FIGS. 3 and 4, the dust-laden air whirls in the cyclone dust body 210 to separate into dust and air. The separated dust is collected on the supporting part 211b and the press filter 240 of the bottom surface 211 of the cyclone body 210, and a part of the separated air passes the press filter 240 and falls out of the cyclone body 210, pressing the dust on the press filter 240 in a direction of arrow F1.

The remaining air, which can not fall out of the press filter 240, rises from the bottom surface 211 of the cyclone body 210 in a direction of arrow F2, passes the cyclone filter 220, passes into the discharge pipe 213 and the air discharge opening 211c, and then falls out of the cyclone body 210.

The dust collected on the press filter 240 is pressed on the press filter 240 by air passing through the press filter 240 such that the collected dust is prevented from flowing back to the cyclone filter 220 to avoid the blocking member 230.

The discharge pipe 213 and the press filter mounting opening 211a are connected with the same suction source in fluid-communication via the connection passage 153, and therefore, a suction force of the suction resource 160 can be transmitted via the press filter 240 and the cyclone filter 220 to the cyclone dust collecting apparatus 200.

Thereafter, the air passing through the press filter to fall out of the cyclone body 210 flows together with the air passing through the cyclone filter, the discharge pipe 213 and the air discharge opening 211c to fall out of the cyclone body 210, and then the joined air stream passes the connection passage 154 and the suction source 160 in a direction of arrow F3 to fall out of the rear side of the cleaner body 150.

As described above, a cyclone dust collecting apparatus 200 and a vacuum cleaner 100 having the same according to an embodiment of the present invention prevents the collected dust from flowing back and sticking to the cyclone filter 220 due to the press filter 240 so that the period of cleaning and fixing can be extended.

Additionally, a suction force can be transmitted via the press filter 240 so that pressure loss can be reduced as compared with a conventional cyclone dust collecting apparatus wherein a suction force is transmitted only via the cyclone filter 220 and the discharge pipe 213 and the complicated process causes pressure losses. Therefore, a cleaning efficiency can increase.

Furthermore, the press filter can press the collected dust for the cyclone dust collecting apparatus to contain a larger amount of dust. As such, the period of discharging dust can be extended.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A cyclone dust collecting apparatus comprising:
a cyclone body;
a press filter provided in the cyclone body; and
a cyclone filter spaced from the press filter,
wherein a part of air in the cyclone body is discharged through the press filter, and the remaining air is discharged through the cyclone filter.

2. The apparatus according to claim 1, further comprising a discharge pipe in the cyclone body, the cyclone filter being disposed at a top portion of the discharge pipe so that air passing through the cyclone filter is discharged through the discharge pipe.

3. The apparatus according to claim 2, wherein the cyclone body comprises a bottom surface having at least one press filter mounting opening and an air discharge opening.

4. The apparatus according to claim 3, wherein the discharge pipe is vertically provided in the cyclone body and is in fluid-communication with the air discharge opening.

5. The apparatus according to claim 3, wherein the bottom surface of the cyclone body is pivotable with regard to a sidewall of the cyclone body so that the cyclone body can be opened.

6. The apparatus according to claim 3, wherein the at least one press filter mounting opening comprises a plurality of the press filter mounting openings that are radially disposed along the air discharge opening in a substantially symmetrical fashion.

7. The apparatus according to claim 6, wherein each press filter mounting opening of the plurality of press filter mounting openings takes on configuration of a trapezoid.

8. The apparatus according to claim 3, wherein the air discharge opening and the at least one press filter mounting opening are in fluid-communication with the same suction source.

9. A vacuum cleaner comprising:
a cleaner body with a suction source;
a suction brush connected with the cleaner body to draw in dust-laden air from a cleaning surface; and
a cyclone dust collecting apparatus detachably mounted in the cleaner body to separate dust from the dust-laden air drawn in from the suction brush, wherein the cyclone dust collecting apparatus comprises a cyclone body, a press filter disposed at a bottom surface of the cyclone body, and a cyclone filter spaced from the press filter, and wherein a part of air in the cyclone body is discharged through the press filter and the remaining air is discharged through the cyclone filter.

10. The vacuum cleaner according to claim 9, further comprising a discharge pipe vertically provided in the cyclone body, wherein the bottom surface includes at least one press filter mounting opening and an air discharge opening, and wherein air passing through the cyclone filter is discharged via the discharge pipe through the air discharge opening.

11. The vacuum cleaner according to claim 10, wherein the discharge pipe and the at least one press filter mounting opening are connected with the same suction source in fluid-communication.

12. The vacuum cleaner according to claim 9, wherein the suction source is arranged in parallel with the cyclone dust collecting apparatus.

13. A cyclone dust collecting apparatus comprising:
a cyclone body;
a press filter provided in the cyclone body; and
a cyclone filter provided in the cyclone body, the press filter and the cyclone filter being in fluid-communication with the same suction source.

14. The apparatus according to claim 13, further comprising a discharge pipe in the cyclone body, the cyclone filter being disposed at a top portion of the discharge pipe so that air passing through the cyclone filter is discharged through the discharge pipe.

15. The apparatus according to claim 14, further comprising a blocking member disposed between the cyclone filter and the entrance of the discharge pipe to prevent dust collected on the press filter from rising towards the cyclone filter.
